(19) United States
(12) Patent Application Publication
(10) Pub. No.: US 2002/0118756 A1
(43) Pub. Date: Aug. 29, 2002

(54) Video coding method and data processing device

(75) Inventors: Seiichi Nakamura, Inagi-shi (JP); Shigeyuki Umeda, Tachikawa-shi (JP)

Correspondence Address: FINNEGAN, HENDERSON, FARABOW, GARRETT &, DUNNER LLP, 1300 I STREET, NW, WASHINGTON, DC, 20005, US

(73) Assignee: KABUSHIKI KAISHA TOSHIBA

(21) Appl. No.: 09/812,783

(22) Filed: Mar. 15, 2001

(30) Foreign Application Priority Data
Jun. 6, 2000 (JP) 2000-168992

(51) Int. Cl. H04N 7/12

(52) U.S. Cl. 375/240.17

(57) ABSTRACT

Video data is compression-coded by an encoder. A processing state or the processing delay of the encoder is detected. The coding of the encoder is controlled based on the processing state of the coding so that a predetermined frame rate of the video data is maintained.

### CROSS-REFERENCE TO RELATED APPLICATIONS

This application is based upon and claims the benefit of priority from the prior Japanese Patent Application No. 2000-168992, filed Jun. 6, 2000, the entire contents of which are incorporated herein by reference.

### BACKGROUND OF THE INVENTION

The present invention relates to a video coding method for compressing and coding video data and a data processing device therefor, and more particularly to a video coding method and a data processing device which are improved to enable smooth reproduction of video data.

In recent years, various types of electronic devices have been developed which correspond to multimedia apparatuses such as digital video players, set top boxes, digital TV's, digital VCR's, personal computers and the like. In recent years, these types of electronic devices have come to be provided with encoders for compressing and coding video data by means of MPEG 2, MPEG 4 or the like in addition to decoders for decoding and reproducing video data compressed and coded with a method for coding video data at a high efficiency such as MPEG 2, MPEG 4 or the like.

In the MPEG 2 or MPEG 4, motion compensation prediction technique through the motion vector detection (a motion estimation: ME) is used. In the motion vector detection, a block search processing is performed wherein the most similar blocks are searched in reference frame for each of the reference blocks in the input frames. A spatial deviation quantity between the searched block and the reference block is determined as the motion vector. Then, the input frame image is predicted from the reference frame on the basis of this motion vector. An orthogonal transformation, quantization, and variable length coding are performed with respect to a deviation signal between the predicted image and the input image. With this motion compensation prediction technique, a highly efficient compression coding is realized.

However, since a large calculation quantity is required in the block search processing for the detection of the motion vector, it takes a lot of time to detect the motion vector so that a delay is generated in the coding processing as a result in some cases. In particular, if software encoding is performed in personal computers, a large processor load is inflicted for the detection of the motion vector. The compression coding processing cannot catch up with the speed of the video data to be input in some cases. A delay in the compression coding processing becomes particularly conspicuous when the video data is compressed and coded with the software in synchronization with the audio data. As a consequence, there arise problems such as deviation of image frames with sound and frame drops in input frames. In such a case, since coding cannot be performed at the target frame rate, an awkward image is generated when the coded data is decoded and reproduced.

Incidentally, one technique for decreasing the calculation quantity in the video compression processing is disclosed in Japanese Unexamined Patent Publication No. 5-40828.

### BRIEF SUMMARY OF THE INVENTION

Accordingly, it is an object of the present invention to provide a video coding method and a data processing device which enable a smooth reproduction of video at the time of reproduction.

According to the present invention, there is provided a video coding method comprising coding video data; and controlling the coding based on a processing state of the coding so that a predetermined frame rate of the video data is maintained.

According to the present invention, there is provided another video coding method comprising filtering video data; coding filtered video data; and controlling at least one of the filtering and the coding based on a processing state of the coding so that a predetermined frame rate of the video data is maintained.

According to the present invention, there is provided a data processing device comprising an encoder configured to code video data; and a controller configured to control the encoder based on a processing state of the encoder so that a predetermined frame rate of the video data is maintained.

According to the present invention, there is provided another data processing device comprising a filter configured to filter video data; an encoder configured to code filtered video data; and a controller configured to control at least one of the filter and the encoded based on a processing state of the encoder so that a predetermined frame rate of the video data is maintained.

According to the present invention, there is provided a video coding method and a data processing device which enable a smooth reproduction of video at the time of reproduction.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the present invention and, together with the general description given above and the detailed description of the preferred embodiments given below, serve to explain the principles of the present invention in which:

FIG. 1 is a block diagram showing a structure of a computer according to a first embodiment of the present invention;

FIG. 2 is a view for explaining a basic function of video compression software used in the first embodiment;

FIG. 3 is a view showing a structure of the video compression software used in the first embodiment;

FIG. 4 is a view showing a function of a compression engine of the video compression software used in the first embodiment;

FIG. 5 is a view showing a function of a video encoder provided in the compression engine according to the first embodiment;

FIG. 6 is a flowchart showing a first example of a procedure of a video compression control processing in the first embodiment;

FIG. 7 is a flowchart showing a first example of the procedure of the image data compression processing in the first embodiment;

FIG. 8 is a view showing a state of the block search range variable control used in the first embodiment;

FIG. 9A is a view for explaining a block tree search used in the first embodiment.;

FIG. 9B is a view for explaining a line skip search used in the first embodiment;

FIG. 10 is a flowchart showing a second example of the procedure of the video compression control processing in the first embodiment;

FIG. 11 is a flowchart showing a second example of the procedure of the image data compression processing in the first embodiment;

FIG. 12 is a view showing a function of a video encoder used in a second embodiment;

FIG. 13 is a flowchart for explaining a control procedure of the video encoder according to the second embodiment; and

FIG. 14 is a flowchart for explaining another example of the procedure in the control processing of the video encoder according to the second embodiment.

### DETAILED DESCRIPTION OF THE INVENTION

A preferred embodiment of a video coding method and a data processing device according to the present invention will now be described with reference to the accompanying drawings.

First Embodiment

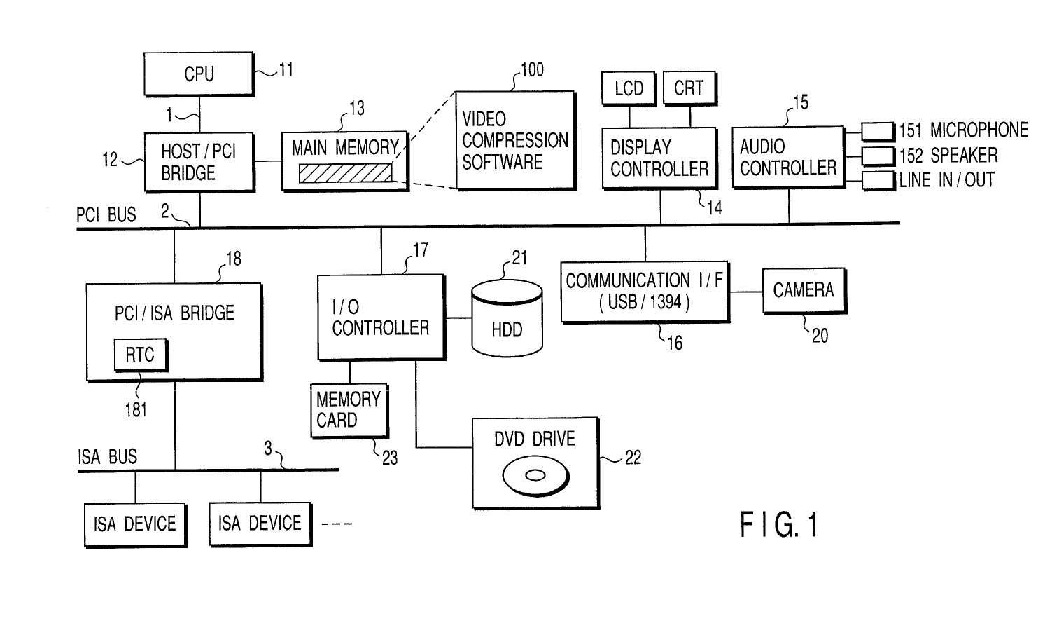

FIG. 1 is a view showing a structure if a personal computer is used as one example of the data processing device according to the first embodiment of the present invention. The personal computer is a portable computer system of a notebook type which is capable of compressing and coding video data input from a video camera or the like by means of MPEG 2/MPEG 4 or the like.

This computer system includes a CPU 11, a HOST/PCI bridge 12, a main memory 13, a display controller 14, an audio controller 15, a communication interface 16, an I/O controller 17, a PCI/ISA bridge 18, a camera 20, a hard disk drive (HDD) 21, a DVD drive 22 and the like.

The CPU 11 is a processor for controlling the whole system based on an operating system and other programs loaded in the main memory 13. In this embodiment, a video compression software 100 is used as a program for compressing and coding the video data. The video compression software 100 can generate AV (audio and video) stream data of compression form such as MPEG 2, MPEG 4 or the like from the input video data, and the AV stream data can be recorded on a storage media as coded file.

The HOST/PCI bridge 12 is a bus bridge connecting the CPU bus 1 and the PCI bus 2. Here, a memory control logic is also incorporated for controlling the main memory 13. The display controller 14 controls an LCD and an external CRT display or the like used as a display monitor of this computer system. If the input video data is compressed and coded while being reproduced, the input video data to be compressed and coded is displayed on the display monitor through the display controller 14. At the same time, the compression coding processing is performed in synchronization with the display of the video data. The audio controller 15 is used as an audio source to input and output audio data through a microphone 151 and a speaker 152.

A communication interface 16 communicates with an external camera or an incorporated video camera 20 through a serial interface standard such as, for example, USB, IEEE 1394 or the like, so that video data can be taken out from the video camera 20. After the video data from the video camera 20 is converted in real time to a compression form such as MPEG 2, MPEG 4 or the like with the control of the video compression software 100, the video data can be recorded on a recording media such as the HDD drive 21, the DVD drive 22, the memory card 23 or the like through the I/O controller 17.

The PCI/ISA bridge 8 is a bus bridge for connecting the PCI bus 2 and the ISA bus 3. Here, system devices such as real time clock (RTC) 181 is incorporated. The real time clock (RTC) 181 is a clock module and is used for time control by the operating system.

Video Compression Software

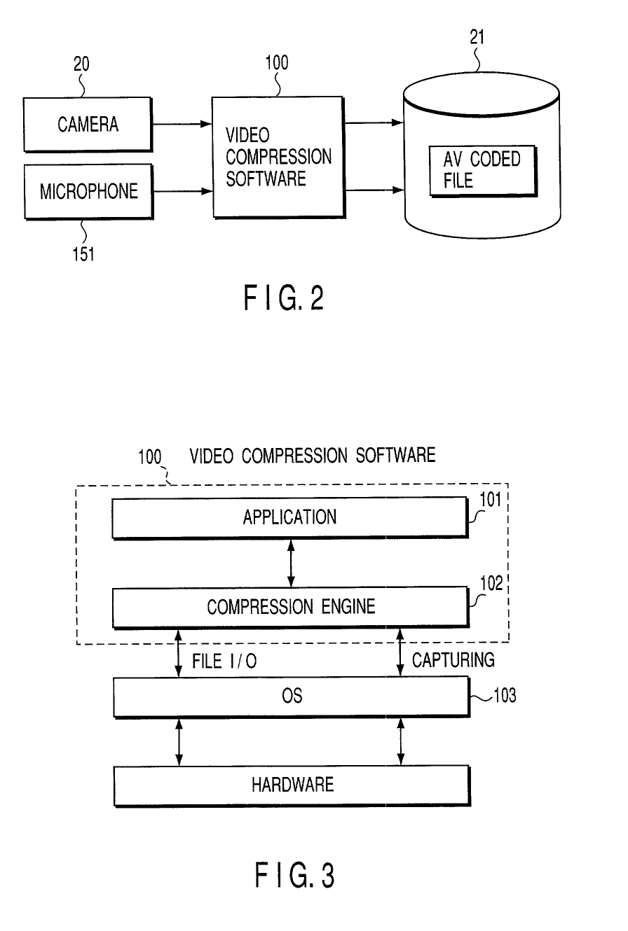

Here, referring to FIGS. 2 and 3, the basic function of the video compression software 100 will be explained.

The video compression software 100 subjects the video data and the audio data input respectively from the camera 20 and the microphone 111 to a compression coding processing, so that the AV coded files thus obtained can be recorded on a storage media such as the HDD drive 21, the DVD drive 22, the memory card 23 or the like. FIG. 2 shows a state of the case in which the AV coded files are recorded by the HDD drive 21. These AV coded files are generated by digitally compressing and coding the video data and the audio data respectively followed by multiplexing the coded bit streams.

As shown in FIG. 3, the video compression software 100 comprises an application program 101 and a compression engine 102. The application program 101 has a user interface for video compression processing and an interface for controlling the compression engine 102 and gives an instruction on an operation required for the capturing and the compression coding to the compression engine 102. The compression engine 102 is a platform for multimedia attached on the operating system (OS) which comprises a group of various program modules (filters) for conducting processing required for the input and output processing of files and the video/audio capturing. These modules can be used in an arbitrary combination under an instruction from the application programs 101.

Compression Engine

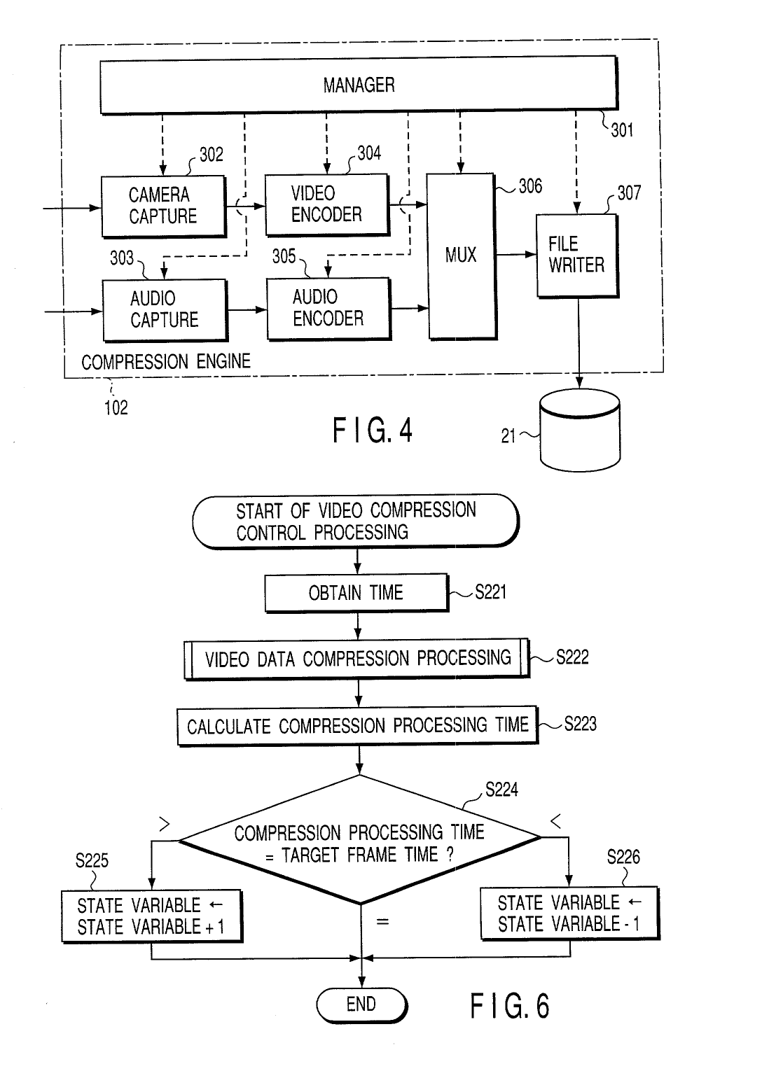

Next, referring to FIG. 4, the function of the compression engine 102 will be explained.

The compression engine 102, as shown in FIG. 4, is realized with a manager 301, a camera capture 302, an audio capture 303, a video encoder 304, an audio encoder 305, a multiplexer 306, and a file writer 307. The operations of the camera capture 302, the audio capture 303, the video encoder 304, the audio encoder 305, the multiplexer 306, and the file writer 307 are controlled with the manager 301.

The video data and the audio data to be compressed and coded are taken in respectively from the camera 20 and the microphone 151 with the camera capture 302 and the audio capture 303. The video data captured with the camera capture 302 is sent to the video encoder 304 where the video data is compressed and coded in real time along with the capturing of the video data. On the other hand, the audio data captured with the audio capture 303 is sent to the audio encoder 305 where the audio data is compressed and coded in real time.

In the compression coding processing of the video data, the motion vector detection (ME) is performed. In the motion vector detection (ME), the block search processing is performed wherein the most similar block is searched out of the reference frames for each of the reference blocks (for example, 8×8 pixels) in the input frame. The spatial deviation quantity between the searched block and the reference block can be determined as the motion vector. Then, on the basis of this motion vector, the image of the input frame is predicted from the reference frame. An error signal between the predicted image and the input image is determined. With respect to the error signal, discrete cosine transformation (DCT), quantization and variable length coding processing are performed by the result that the coded bit stream is generated. Besides, inverse quantization and inverse DCT are performed with respect to the quantized block so that the reference frame for prediction coding between frames is generated.

The coded bit stream of the video data obtained with the video encoder 304 and the coded bit stream of the audio data obtained with the audio encoder 305 are sent to the multiplexer 306 to be multiplexed there. The multiplexed coded bit stream is sent to the file writer 307 and is converted into the form of a predetermined AV coded file followed by being written onto the HDD drive 21 or the like.

Video Encoder

Next, referring to FIG. 5, a structure of the video encoder 304 will be explained.

The video encoder 304 comprises, as shown in FIG. 5, an input module 501, an encode module 502, an output module 503, and a control module 504.

The input module 501 inputs the video data via the camera capture 302. The encode module 502 is a function module for subjecting the video data input with the input module 501 to the compression coding processing. Under the control of the control module 504, the input frame is subjected to the compression coding processing. The result of the compression coding processing is sent back to the control module 504. The output module 503 outputs the coded bit stream obtained with the encode module 502 to the multiplexer 306 described above.

The control module 504 controls the operation of each of the modules 501, 502, and 503 in the video encoder 404. The encode module 502 is called for each of the input frames. The encode module 502 is allowed to perform the compression coding processing with respect to the input frame. In this control module 504, there is provided a function of controlling the processing state of the compression coding processing by the encode module 502. The processing content of the compression coding processing which the encode module 502 performs is optimized on the basis of the processing state of the compression coding processing of the encode module 502. The control of the processing content of the compression coding processing is performed by changing the parameter of the coding option which is handed to the encode module 502 when the encode module 502 is called.

The control module 504 has a CPU load detection module 601, a target frame rate 602, and a state variable “X” 603. The CPU load detection module 601 detects the current load of the CPU 11 on the basis of time required for the compression coding processing. That is, the CPU load detection module 601 constantly monitors the elapsed time T (=the processing time of the compression coding processing) from the call of the encode module 502 up to the return for each of the frames, and determines the progress state of the compression coding processing, namely, the current load of the CPU 11 on the basis of the elapsed time T and the value of the target frame rate 602 designated by the user through the application program 101.

If the current load of the CPU 11 is relatively high, and a delay is generated in the compression coding processing with respect to the value of the target frame rate 602, the value of the state variable “X” 603 is increased. On the contrary, if the current load of the CPU 11 is relatively low, and a larger CPU resource can be allocated to the compression coding processing, the value of the state variable “X” 603 is decreased. On the basis of the value of the state variable “X” 603, the parameter of the coding option which should be designated with respect to the encode module 502 is determined.

Hereinafter, several cases of the video compression control processing will be explained in accordance with the load of the CPU 11.

Video Compression Control Processing #1

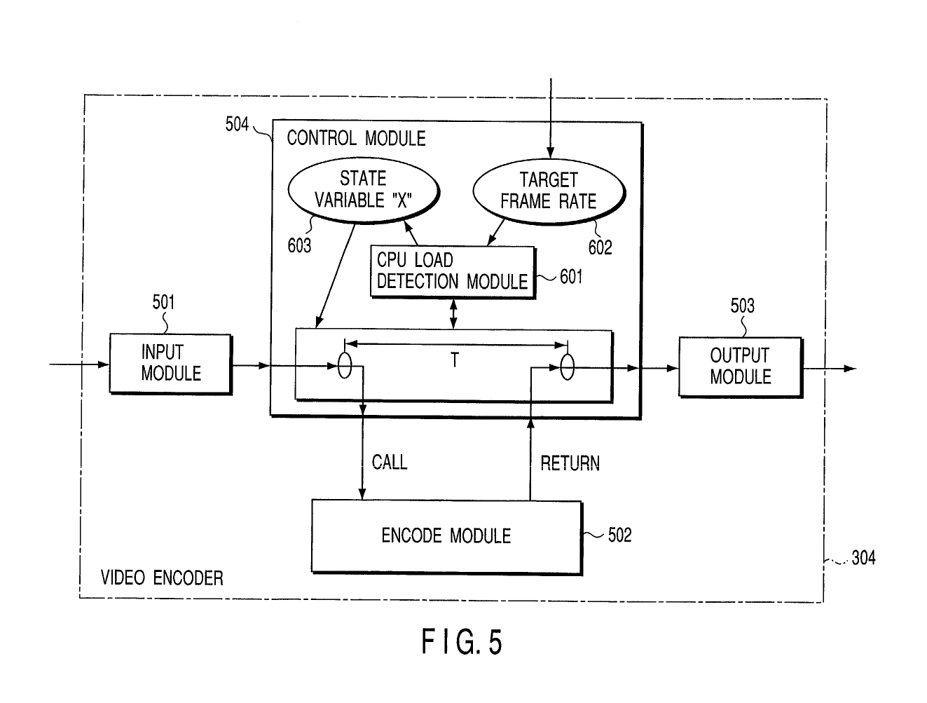

Next, referring to the flowchart of FIG. 6, the whole flow of the video compression control will be explained which is performed by the encode module 304.

The control module 504 obtains the processing start time (the current time) from the operating system before the control module 504 allows the encode module 502 to perform the compression coding processing of the input frame (step S221). Next, the control module 504 calls the encode module 502 to perform the compression coding processing with respect to the current input frame (step S222). When the compression coding processing for one frame by the encode module 502 is completed, the control is brought back to the control module 504 from the encode module 502. The control module 504 obtains the processing end time from the operating system 103 to calculate the compression processing time T by taking a difference with the processing start time (step S223).

Next, the control module 504 compares the compression processing time T with the target one frame time which is an inverse of the target frame rate 602 to determine the processing state of the compression coding processing (step S224). If the value of the compression processing time T is larger than the frame time interval designated with the target frame rate 602, namely, if the compression coding processing is delayed, the control module 504 updates the state variable “X” 603 by incrementing the value thereof (step S225). On the other hand, if the value of the compression coding processing T is smaller than the frame time interval designated in the target frame rate 602, namely, if there is room for the CPU 11, the control module 504 updates the state variable “X” 603 by decrementing the value thereof (step S225).

If the value of the compression processing time T is equal to the frame time interval designated with the target frame rate 602, the state variable “X” 603 is not updated.

Video Data Compression Processing

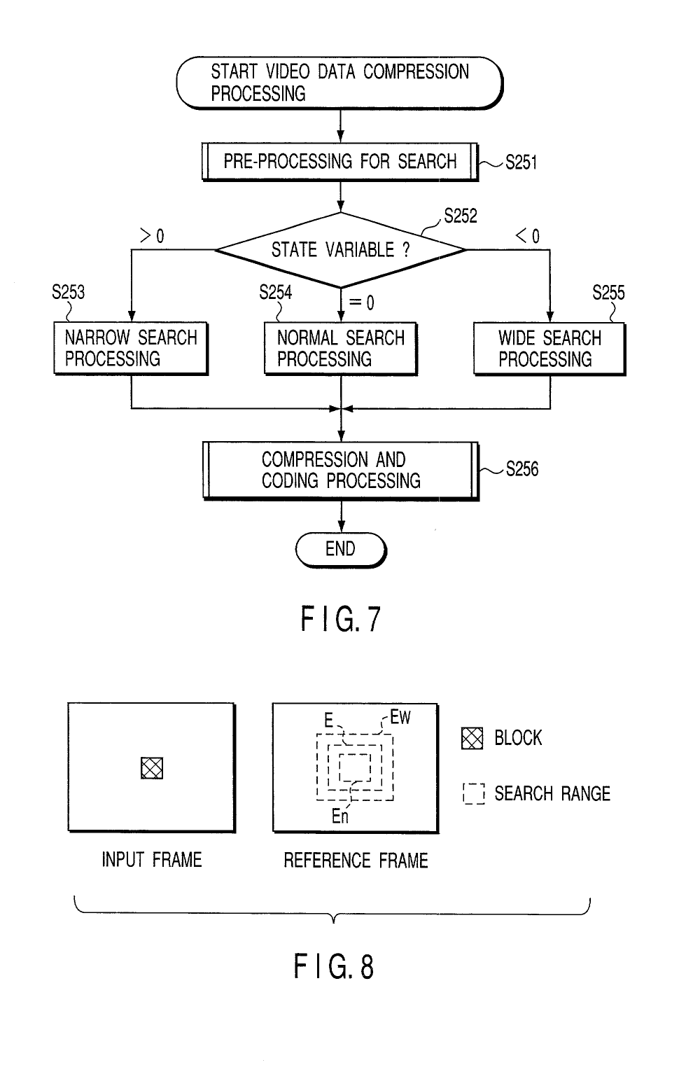

Next, referring to the flowchart of FIG. 7, the flow of the compression coding processing performed by the encode module 502 will be explained.

The processing for extracting the block to be compressed from the input frame, the processing for preparing for the reference frame to be searched and the like are performed as a pre-processing for search (step S251). Next, the processing of the motion vector detection is started. However, in this case, the range in which the block is to be searched is variably controlled on the basis of the value of the current state variable “X” 603 (steps S252 through S255). The state thereof is shown in FIG. 8. That is,

1) Where the value of the state variable “X” 603 is larger than 0, a search range En narrower than the normal range E is designated with the control module 504 to alleviate the CPU load.

2) Where the state variable “X” 603 is 0, the normal search range E is designated with the control module 504.

3) Where the value of the state variable “X” 603 is smaller than 0, the search range Ew wider than normal search range E is designated with the control module 504 in order to heighten a coding efficiency.

The processing of searching the block is performed on the basis of the designated search range.

In this manner, the motion vector is detected in the block search, and the image of the input frame is predicted on the basis of the motion vector. An error signal between the predicted image and the input image is determined. Then, with respect to the error signal, discrete cosine transformation (DCT), quantization and variable length coding processing are performed (step S256).

In this manner, the compression coding processing is not delayed with respect to the input image by rendering variable the block search range in accordance with the load of the CPU. Therefore, problems such as a deviation with the sound and an inevitable frame drop of the input frame can be settled, so that the highest image quality can be attained by maintaining the frame rate.

Furthermore, both image quality and the frame rate can be established finer by using the block tree search and one line skip search as a technique of search within the block as well as the variable control of the simple search range.

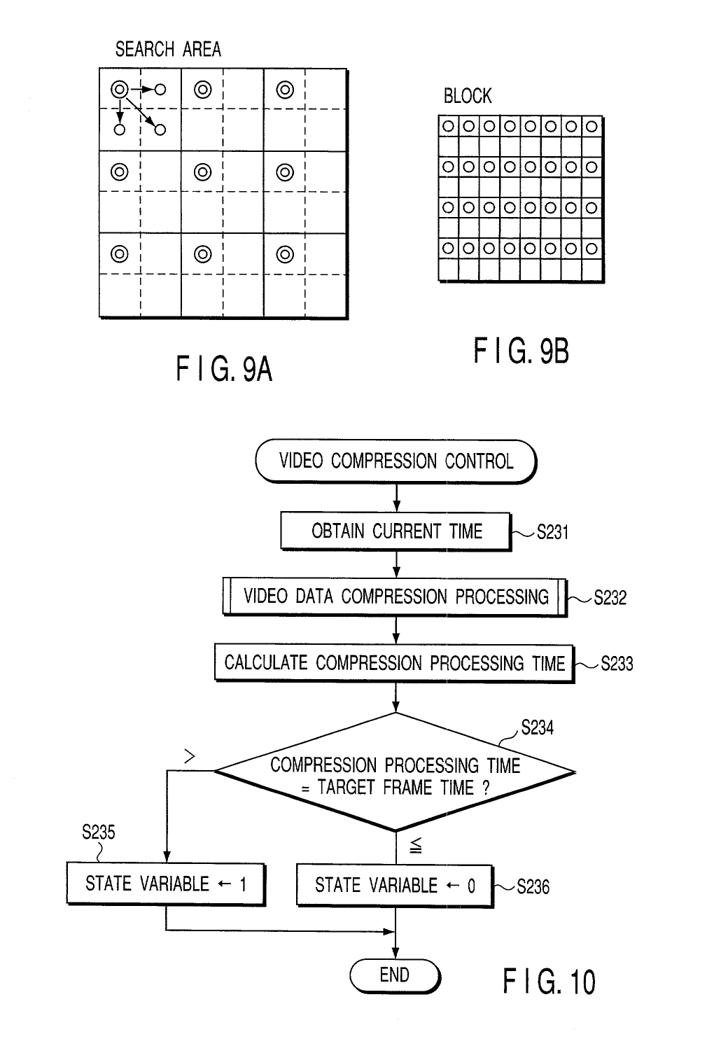

As shown in FIG. 9A, in the block tree search all the blocks in the search range are divided into several groups, the representative blocks (denoted with a double circle) of each group in the reference frame are compared with the representative block of the reference group in the input frame and the most similar representative block is determined. Next, comparison of all the blocks with other blocks (denoted with a single circle) in the determined group is performed so that the block most similar to thee reference block is determined. As a consequence, the number of blocks to be compared with the reference block can be eliminated, and an attempt can be made to alleviate the processing.

The one line skip search is such that pixels between the blocks are compared by skipping one line as shown in FIG. 9B. A similarity between the pixels of two lines in the adjacent vertical direction is high. Through such a procedure, the calculation processing quantity for comparison can be alleviated.

For example, if the value of -the state variable “X” 603 is 1, the search range EN narrower than the normal range E is designated. If -the value of the state variable “X” 603 is 2, the search range EN narrower than normal range E is designated, and, in addition, either the block tree search or one line skip search is designated. Furthermore, if the value of the state variable “X” 603 is 3, the search range EN narrower than the normal range E is designated, and, in addition, both the block tree search and one line skip search are designated so that the calculation processing quantity can be decreased step by step depending upon the delay quantity.

As has been explained above, the load of the CPU is determined depending upon the progress state of the compression coding processing, the processing quantity of the compression coding processing is adjusted depending upon the load, and the occurrence of the frame drop at the time of the compression coding processing can be eliminated as much as possible.

Video Compression Control Processing #2

Next, referring to the flowchart of FIG. 10, there will be explained a second example of the video compression control performed by the video encoder 304. In the first example, the state variable “X” 603 has been controlled with the multiple values in accordance with the load of the CPU 11. Here, the state variable “X” 603 is controlled with only two values “0” and “1”.

The control module 504 obtains the processing start time (the current time) from the operating system 103 before the control module 504 allows the encode module 502 to perform the compression coding processing of the input frame 502 (step S231). Next, the control module 504 calls the encode module 502 to perform the compression coding processing with respect to the current input frame (step S232). When the compression coding processing for one frame by the encode module 502 is completed, the control is brought back from the encode module 502 to the control module 504. The control module 504 obtains the processing end time from the operating system 103 and calculates the compression processing time T by taking a difference between the processing start time and the processing start time (step S233).

Next, the control module 504 compares the compression processing time T and the target one frame time which is the inverse of the target frame rate 602 to determine the processing state of the compression coding processing (step S234). If the value of the compression processing time T is larger than the frame time interval, namely, if the compression coding processing is delayed, the control module 504 sets the value of the state variable “X” 603 to “1” (step S235). On the other hand, if the value of the compression processing time T is either equal to or smaller than the frame time interval designated with the target frame rate 602, the control module 504 sets the value of the state variable “X” 603 to “1” (step S225).

Video data Compression Processing

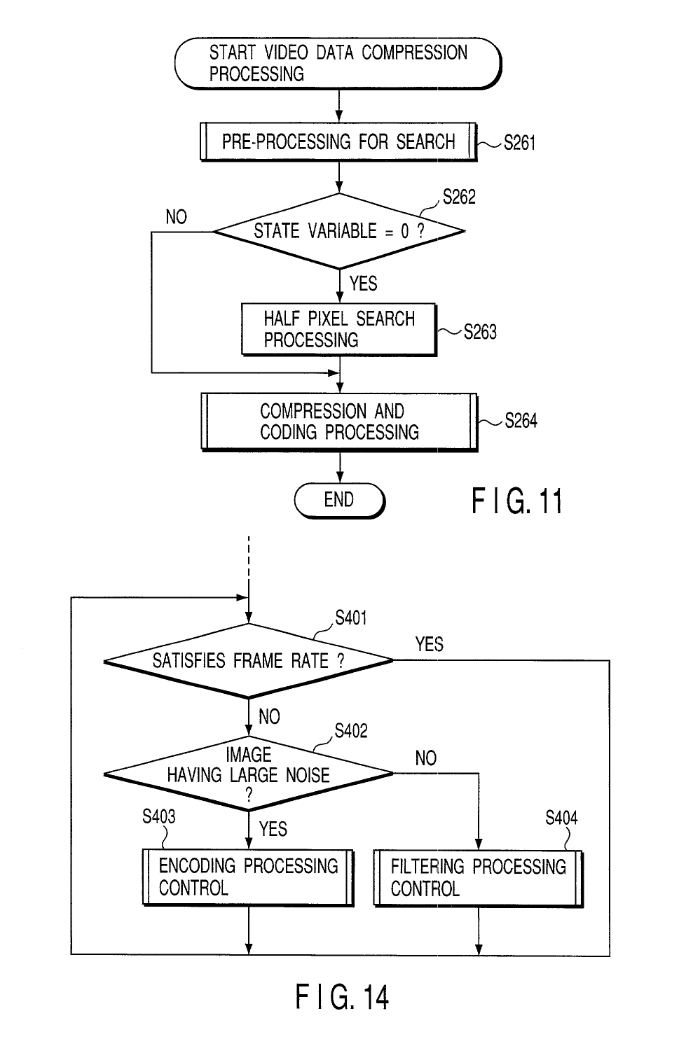

Next, referring to the flowchart of FIG. 11, there will be explained the control of the compression coding processing corresponding to the state variable control of FIG. 10.

After the processing of extracting the block to be compressed from the input frame and the processing of preparing for the reference frame to be searched are performed as a processing prior to the search, the normal block search processing is performed at the precision of integer pixel (step S261). In this case, the search range is a normal definite search range.

Next, a high precision block search (a half pixel search) is started at a high precision of the pixel precision of 0.5 pixels which accompanies the processing for linear interpolating between respective pixels within the reference frame, but this half pixel search is designated as an option to be performed or skipped on the basis of the value of the state variable “X” 603.

That is, when the value of the state variable “X” 603 is “0” (YES at step S262), the half pixel search processing is performed (step S263) and a high precision motion vector detection is performed. On the other hand, when the value of the state variable “X” 603 is “1” (NO at step S262), the half pixel search processing is skipped, and the motion vector detection is performed on the basis of the block search result at step S261 performed in a precision of the integer pixel.

Then, thereafter, the image of the input frame is predicted from the reference frame on the basis of the detected motion vector so that an error signal between the predicted image and the input image is determined. Then, with respect to the error signal, the discrete cosine transformation (DCT), quantization and the variable length coding processing are performed (step S264).

In this example as well, the load of the CPU 11 is determined depending upon the progress state of the compression coding processing, so that the processing quantity of the compression coding processing is adjusted depending upon the load and the occurrence of the frame drop at the time of the compression coding processing can be eliminated as much as possible.

According to the present embodiment, the processing content of the compression coding processing is controlled on the basis of the processing situation of the compression coding processing, so that the compression coding processing optimal for the processing situation of the current compression coding processing can be performed. Consequently, if the processor load is large, and a delay is generated in the compression coding processing, the processing is converted into compression coding processing in which calculation processing is infrequent thereby making it possible to maintain a predetermined target frame rate. On the contrary, if there is some room in the processor, the compression rate can be improved by converting the processing into the highly efficient compression coding processing in which the calculation processing quantity is large.

With respect to the processing state of the compression coding processing, processing time required for the compression coding processing is detected, and the processing state can be determined from the detected processing time and the predetermined frame rates. The processing time required for the compression coding processing changes depending on the load of the processor so that the detection of the processing time required for compression coding will result in the detection of the processor load.

In the compression coding processing, since a lot of time is spent in the detection processing of the motion vector, it is preferable to control the processing content of the motion vector processing which is performed in the compression coding processing. Specifically, it becomes possible to optimize the content of the compression coding processing by variably controlling the search range and the search precision of the block search processing which is performed in processing of the motion vector detection.

As has been explained according to the embodiment, the load of the CPU is determined depending upon the time from the start of the coding from the call of the encode module to the return up to the end of the coding to render variable the coding processing depending upon this load with the result that the time from the start of the coding up to the end of the coding can be set within a desired frame rate thereby making it possible to prevent the occurrence of the frame drop at the time of the compression coding processing as much as possible.

Next, another embodiment of the present invention will be explained. In the forgoing embodiment, the portions corresponding to the first. embodiment are denoted with the same reference numerals and detailed explanation thereof will be omitted.

Second Embodiment

A second embodiment is different from the first embodiment only in the structure of the video encoder 304, and the second embodiment is the same as the first embodiment in other respects.

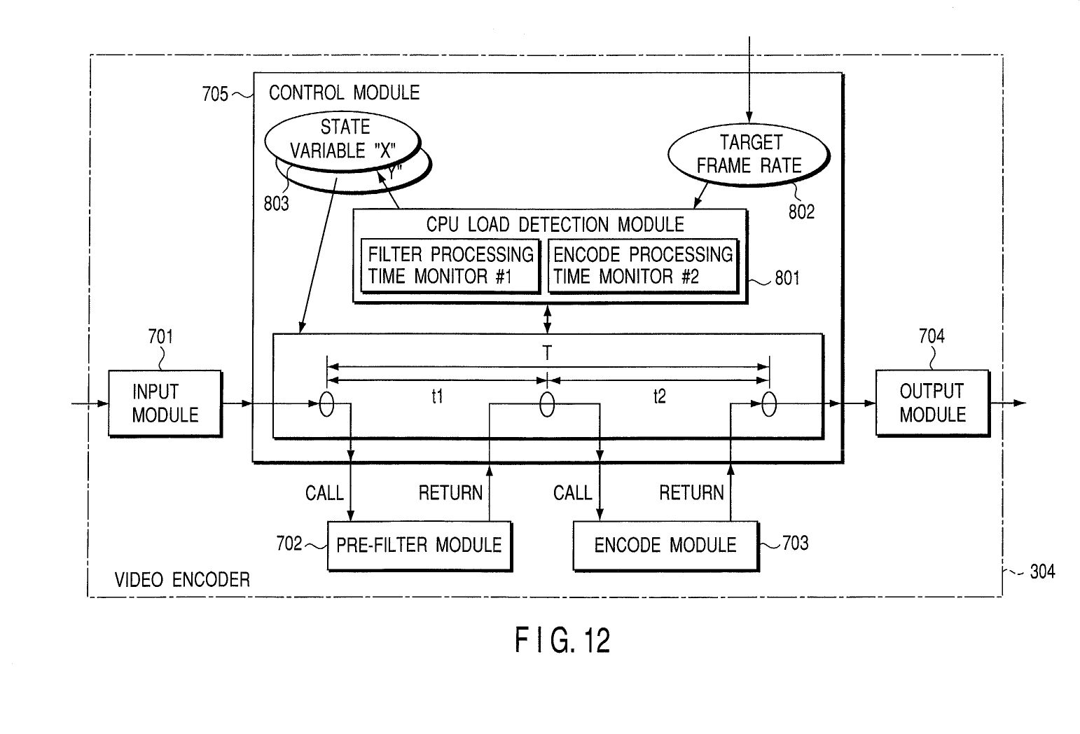

FIG. 12 is a view showing a structure of a video encoder 304 used in the second embodiment.

The video encoder 304 comprises, as shown in FIG. 12, an input module 701, a pre-filter module 702, an encode module 703, an output module 704, and a control module 705.

The input module 701 corresponds to the input module 501 of FIG. 10, and the input module 701 inputs the video data taken in with the camera capture 302. The pre-filter module 702 performs a smoothing filtering processing (a high frequency cut) for the improvement of the image quality such as noise removal or the like with respect to the input frame under the control of the control module 705, and brings back the input frame after the filter processing. Various filtering processing different in the processing speed and the filter effect can be performed with respect to the input frame to be compressed and coded by the change-over of the type of filters (an IRR filter, and a FIR filter) and the setting of the filter parameters.

The encode module 703 corresponds to the encode module of FIG. 5. A compression coding processing is performed with respect to the input frame under the control of the control module 705 to bring back the result of the compression coding processing to the control module 705. The output module 704 corresponds to the output module 503 of FIG. 5., The coded bit stream obtained with the encode module 703 is output to the multiplexer 306 described above.

The control module 705 corresponds to the control module 504 of FIG. 5. This control module 705 includes a function of controlling the processing state of the filtering processing by the pre-filter module 702 in addition to the function of controlling the processing state of the compression coding processing by the encode module 703. The filter processing is optimized and controlled so that at least the designated target frame rate can be maintained.

The control module 705 has a CPU load detection module 801, a target frame rate 802, and two state variables “X” and “Y” 803. The CPU load detection module 801 has a filtering processing time monitor function #1 for detecting time required for the filtering processing of the pre-filter module 702 and an encode processing time monitor function #2 for detecting time required for compression coding processing of the encode module 703. The current load of the CPU is detected by using these processing monitor functions. That is, the CPU load detection module 801 constantly monitors the elapsed time t1 (=the processing time of the filtering processing) from the call of the pre-filter module 702 up to the return and the elapsed time t2 (=the processing time of the compression coding processing) from the call of the encode module 703 up to the return to control individually the processing state with respect to the filtering processing and the compression coding processing. The processing state of the filtering processing is controlled with the state variable “X” by the same method as the first embodiment.

As the state variable “Y”, for example, the variables of two values “0” and “1” can be used. When the state variable “Y”=“1” is established, a normal filtering processing is performed. However, when the state variable “Y”=“0” is established, the processing is changed over to the filtering processing where the calculation processing quality is small, or the filtering processing is skipped.

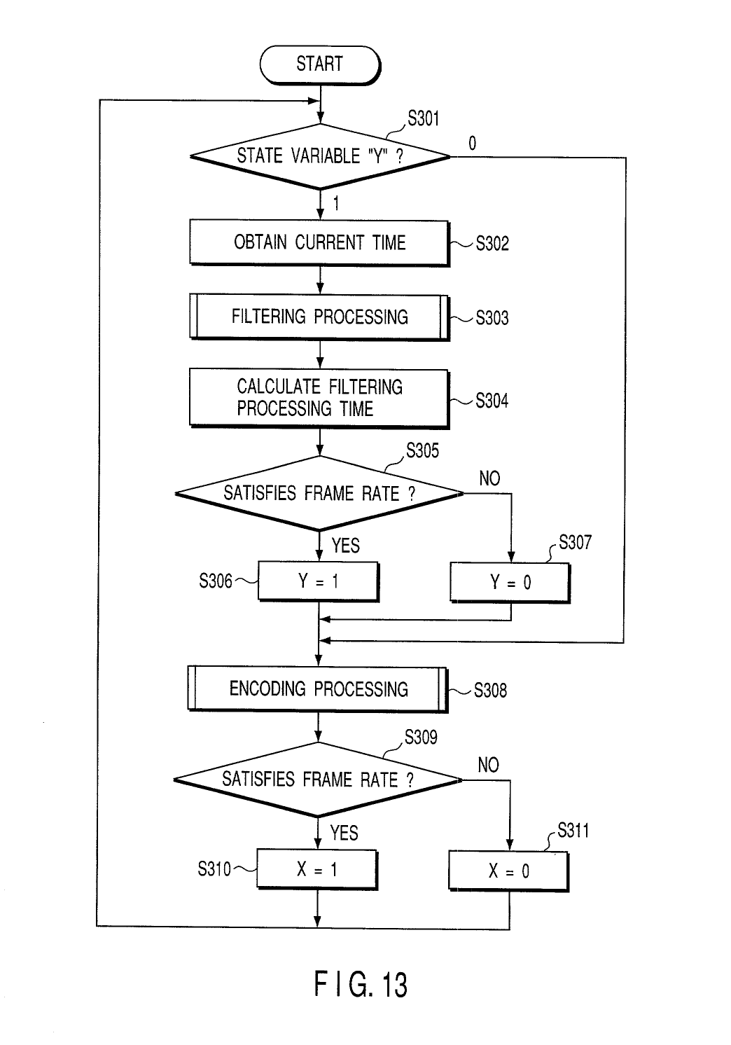

Hereinafter, referring to the flowchart of FIG. 13, there will be explained an operation of the video encoder 304 of FIG. 12. Here, the explanation is made by citing an example showing the case in which the filtering processing is skipped when the state variable “Y”=“0” is set.

The control module 705 refers to the current state variable “Y” to determine whether or not the state variable “Y” is either “0” or “1” (step S301). If the state variable Y=“0”, the filtering processing is skipped to move to the encode processing (step S308) by the encode module 703. On the other hand, if the state variable “Y”=“1”, the following filtering processing control is performed.

That is, before the control module 705 allows the pre-filter module 702 to perform the filtering processing of the input frame, the control module 705 obtains, the processing start time (the current time) from the operating system 103 (step S302). Next, the control module 705 calls the pre-filter module 702 to perform the filtering processing with respect to the current input frame (step S303). When the filtering processing is completed, the control is brought back from the pre-filter module 702 to the control module 703. The control module 705 obtains the processing end time at this time from the operating system 103 to calculate the filter processing time t1 by taking a difference between the processing start time and the processing end time (step S304).

Next, the control module 705 determines whether or not time T (=t1+t2) required for the whole video compression can be set within the frame time interval of the target frame rate 802 by taking into consideration the calculated filtering processing time t1 and the normal compression coding processing time t2 (step S305). When the time T is set within the frame time interval of the target frame rate, the control module 705 maintains the state variable “Y” to “1” (step S306). However, when the filtering processing takes a long time, and the time T required for the video compression becomes larger than the frame time interval of the target frame rate 802, the control module 705 sets the state variable “Y” to “0” (step S307).

In the subsequent encoding processing (step S308) by the encode module 703, the processing explained in FIGS. 6 and 7 or the processing explained in FIGS. 10 and 11 is performed. For example, the control of the calculation processing quantity associated with the compression coding processing (the renewal of the state variable “X” and the variable control of the block search range based on the state variable “X”) is performed on the basis of the scale relation between the actual compression coding processing time t2 and the remaining time resulting from the subtraction of the normal filtering processing time from the frame time interval of the target frame rate 80.

After this, the control module 705 determines whether or not the value resulting from the addition of the normal filtering processing time t1 to the compression coding time t2 is set within the frame time interval of the target frame rate 802 (step S309). When the value is set within the frame time interval, the state variable “X” is set to “1” (step S310). When the value is not set within the frame time interval, the state variable “X” is set to “0” (step S311).

In this manner, images having the highest quality can be compressed and coded while maintaining the frame rate by monitoring time required for the pre-filtering processing and time required for the encode processing, skipping the pre-filter, and changing the processing (the search range and the search method) of the encode processing.

Incidentally, in the second embodiment, there has been explained a case in which the control of the filtering processing and the control of the compression coding processing are combined to be used. However, only one of the filtering processing and the compression coding processing may be controlled in accordance with the load of the CPU. One example of this case is shown in FIG. 14.

It is determined whether or not the time T (=t1+t2) required for the whole video compression is set within the frame time interval of the target frame rate 802 (step S401). If the load of the CPU is large, and the time T exceeds the frame time interval, it is determined whether the image is a low quality image having a large noise, or the image is a high quality having a small noise (step S402). This determination is, for example, on the basis of the image quality information or the like associated with the input video data designated from the user through the application program 101. If the image is a low quality image having a large noise, the noise exerts a large influence upon the image quality after the compression coding processing if the filtering processing is not performed. Consequently, calculation quantity is not decreased with respect to the filtering processing only the processing is performed for decreasing the calculation processing of the compression coding processing (step S403). On the other hand, if the image is a high quality image having a small noise, a high quality coded image can be obtained without performing the filtering processing, so that only the processing (including the filtering processing skip) is performed for decreasing the calculation quantity of the filtering processing (step S404).

According to the present embodiment, a filtering processing is performed with respect to the video data prior to the compression coding processing, the filtering processing may be controlled on the basis of the current compression coding processing. It is possible to maintain the predetermined frame rate that is targeted, for example, by skipping the filter processing, or changing the type of the filtering processing. It goes without saying that such filter processing control can be used in combination with the control of the compression coding processing, but only one of the two may be controlled.

As has been described above, according to each of the embodiments, it becomes possible to optimize and control the compression coding processing (furthermore, the filtering processing) in accordance with the load of the CPU while maintaining the target frame rate. Furthermore, the software encoding method according to each of the embodiments can be easily realized only by introducing into a normal computer a computer program including the procedure through a recording medium which can be read with the computer. Furthermore, when the software is encoded on the microprocessor base, the method is effective even when the method is applied, for example, to digital video cameras and other kinds of electronic devices.

Additional advantages and modifications will readily occur to those skilled in the art. Therefore, the present invention in its broader aspects is not limited to the specific details, representative devices, and illustrated examples shown and described herein. Accordingly, various modifications may be made without departing from the spirit or scope of the general inventive concept as defined by the appended claims and their equivalents. For example, each of the embodiments is explained as an independent embodiment, but a plurality of embodiments may be combined in an appropriate manner. Furthermore, the above embodiments include various stages of the invention, so that various forms of the invention can be extracted with an appropriate combination of a plurality of constituent requirements that have been disclosed. For example, even when several constituent requirements are eliminated from all the constituent requirements shown in the embodiments, the problems described in the passage describing the problems to be solved by the invention can be settled. If the effect described in the passage describing the effect of the invention can be obtained, the structure in which this constituent requirement is eliminated can be extracted as the invention.

As has been described in the invention, the occurrence of the frame drop at the time of the compression coding processing can be prevented as much as possible with the result that a smooth reproduction of the video can be made possible at the time of reproduction.

What is claimed is:

1. A video coding method comprising:
coding video data; and
controlling the coding so as to maintain a predetermined frame rate of the video data.

2. The video coding method according to claim 1, wherein the controlling comprises:
detecting a processing time required for the coding; and
controlling the coding based on a detected processing time and the predetermined frame rate.

3. The video coding method according to claim 1, wherein the controlling comprises controlling a motion vector detection in the coding.

4. The video coding method according to claim 3, wherein the controlling comprises controlling a search range or a search precision of a block search in the motion vector detection.

5. The video coding method according to claim 1, further comprising filtering the video data prior to the coding, and
wherein the controlling comprising controlling the filtering based on the processing state of the coding so that the predetermined frame rate is maintained.

6. The video coding method according to claim 1, wherein the coding is performed by allowing a CPU to perform a computer program for the coding, and
the controlling comprises detecting a load of the CPU and controlling the coding based on the load of the CPU.

7. A video coding method comprising:
filtering video data;
coding filtered video data; and
controlling at least one of the filtering and the coding so as to maintain a predetermined frame rate of the video data.

8. The video coding method according to claim 7, wherein the controlling comprises:
detecting a processing time required for the coding; and
controlling the coding based on a detected processing time and the predetermined frame rate.

9. The video coding method according to claim 7, wherein the controlling comprises controlling a motion vector detection in the coding.

10. The video coding method according to claim 7, wherein the controlling comprises controlling a search range or a search precision of a block search in the motion vector detection.

11. The video coding method according to claim 7, wherein the coding is performed by allowing a CPU to perform a computer program for the coding, and
the controlling comprises detecting a load of the CPU and controlling the coding based on the load of the CPU.

12. A data processing device comprising:
an encoder configured to code video data; and
a controller configured to control the encoder so at to maintain a predetermined frame rate of the video data.

13. The data processing device according to claim 12, further comprising a detector configured to detect a processing time of the encoder required for a coding, and wherein said controller controls the encoder based on a detected processing time and the predetermined frame rate.

14. The data processing device according to claim 12, wherein the controller controls a motion vector detection in a coding performed by the encoder.

15. The data processing device according to claim 12, wherein the encoder comprises a CPU operated based on a computer program for the coding, and
the controller detects a load of the CPU and controls the encoder based on the load of the CPU.

16. A data processing device comprising:
a filter configured to filter video data;
an encoder configured to code filtered video data; and
a controller configured to control at least one of the filter and the encoded so as to maintain a predetermined frame rate of the video data.

17. A computer program product configured to store program instructions for execution on a computer system enabling the computer system to perform:
coding video data; and
controlling the coding so as to maintain a predetermined frame rate of the video data.

18. The computer program product according to claim 17, wherein the program instruction to controlling comprises sub-instructions to perform:
detecting a processing time required for the coding; and
controlling the coding based on a detected processing time and the predetermined frame rate.

19. The computer program product according to claim 17, further comprising a program instruction to filtering the video data prior to the coding, and
wherein the program instruction to controlling comprising a sub-instruction to controlling the filtering based on the processing state of the coding so that the predetermined frame rate is maintained.
